(19) United States
(12) Patent Application Publication
(10) Pub. No.: US 2008/0109229 A1
(43) Pub. Date: May 8, 2008

(54) SOUND DATA PROCESSING APPARATUS

(75) Inventor: Akihito Suzuki, Osaka (JP)

Correspondence Address: CANTOR COLBURN, LLP, 20 Church Street, 22nd Floor, Hartford, CT, 06103, US

(73) Assignees: SANYO ELECTRIC CO., LTD., Osaka (JP); SANYO SEMICONDUCTOR CO., LTD., Gunma (JP)

(21) Appl. No.: 11/924,895

(22) Filed: Oct. 26, 2007

(30) Foreign Application Priority Data
Oct. 26, 2006 (JP) JP2006-290911

(51) Int. Cl. G10L 21/00

(52) U.S. Cl. 704/500

(57) ABSTRACT

A sound data processing apparatus includes a digital signal processor capable of decoding sound data, a buffer memory functioning as a ring buffer for successively storing the decoded sound data, a data reading controller configured to read sound data from the buffer memory, a DAC-FIFO buffer or a DIT-FIFO buffer storing sound data input from the data reading controller, and a digital/analog converter (DAC) or a digital interface transmitter (DIT) that outputs an interrupt signal to the data reading controller when the sound data stored in the DAC-FIFO buffer memory or the DIT-FIFO buffer memory is equal to or less than a predetermined amount. The data reading controller reads sound data from the buffer memory in response to the interrupt signal if a write pointer value is equal to a read pointer value.

### CROSS-REFERENCE TO RELATED APPLICATION

This application claims priority to Japanese Patent Application No. 2006-290911, filed on Oct. 26, 2006.

### BACKGROUND OF THE INVENTION

1. Field of the Invention

The present invention relates to a sound data processing apparatus configured to perform processing on sound data used in communication.

2. Description of the Related Art

The Moving Picture Expert Group (MPEG) coding method is widely used for compressing and transmitting image data and sound data in television broadcasting and other forms of communication.

A transmitting apparatus performing communications in accordance with the MPEG coding technique generates a transport stream packet (TS packet) consisting of coded elements such as image data, sound data, and character data. A receiving apparatus includes a decoder that decodes image data, sound data, and character data extracted and separated from a received TS packet. The receiving apparatus includes a first-in first-out (FIFO) buffer memory that can buffer decoded data and successively output the buffered data.

FIG. 5 illustrates a conventional sound data processing apparatus 100. The sound data processing apparatus 100 includes an input module 10, a digital signal processor (DSP) 12, an intermediate buffer module 14, a buffer memory 16, a digital/analog converter (DAC) 18, a DAC-FIFO buffer memory 20 (i.e., an FIFO buffer memory dedicated to the DAC 18), a digital interface transmitter (DIT) 22, and a DIT-FIFO buffer memory 24 (i.e., an FIFO buffer memory dedicated to the DIT 22).

The input module 10 receives sound data (i.e., data having been subjected to compression and coding processing beforehand) which is separated from a TS packet. The input module 10 transfers the received sound data to the DSP 12. The DSP 12 performs expansion processing and decoding processing on the received sound data and outputs the processed sound data to the intermediate buffer module 14. The intermediate buffer module 14 controls reading/writing of data from/to the buffer memory 16. The intermediate buffer module 14 receives sound data from the DSP 12 and performs predetermined processing on the received sound data. The processing performed by the intermediate buffer module 14 includes adjusting a bit width of the sound data in accordance with a bus width of the buffer memory 16. The buffer memory 16 stores the sound data received from the intermediate buffer module 14. The buffer memory 16 has a memory capacity capable of storing sound data constituting one frame. The buffer memory 16 successively stores sound data received from the intermediate buffer module 14.

The DSP 12 receives an interrupt signal from the DAC 18 or the DIT 22. When an interrupt signal is input from the DAC 18 or the DIT 22, the DSP 12 instructs the intermediate buffer module 14 to read sound data. In response to the reading instruction received from the DSP 12, the intermediate buffer module 14 reads sound data from the buffer memory 16 and transfers the read sound data to the DSP 12. The DSP 12 outputs the read sound data to the DAC 18 or the DIT 22.

The DAC 18 and the DAC-FIFO buffer memory 20 convert the sound data into data having an appropriate format that can be processed by a sound data D/A converter connected to the sound data processing apparatus 100, and output the converted sound data to the sound data D/A converter. The DAC 18 receives sound data having been expanded and decoded by the DSP 12 and transfers the same, via a built-in register, to the DAC-FIFO buffer memory 20, which stores the sound data. The DAC-FIFO buffer memory 20, for example, includes a buffer memory of 32 words×2 banks for each channel of sound data. The DAC-FIFO buffer memory 20 has a first-in first-out function. The DAC 18 successively reads sound data from the DAC-FIFO buffer memory 20, performs format conversion processing on the input sound data, and outputs the processed sound data to an external device. Furthermore, the DAC 18 outputs an interrupt signal to the DSP 12 when the DAC-FIFO buffer memory 20 stores no sound data.

The DIT 22 and the DIT-FIFO buffer memory 24 convert the sound data into data having an appropriate format that can be processed by an external apparatus connected to the sound data processing apparatus 100, and output the converted sound data to the external apparatus. The DIT 22 receives sound data having been expanded and decoded by the DSP 12 and transfers, via a built-in register, to the DIT-FIFO buffer memory 24. The DIT-FIFO buffer memory 24, for example, includes a memory of 32 words×2 banks for each channel of sound data. The DIT-FIFO buffer memory 24 has a first-in first-out function. Furthermore, the DIT 22 successively reads and performs format conversion processing on sound data input from the DIT-FIFO buffer memory 24, and outputs the processed sound data to an external device. Furthermore, the DIT 22 outputs an interrupt signal to the DSP 12 when the DIT-FIFO buffer memory 24 stores no sound data.

The sound data processing apparatus 100 repeats the above-described processing a predetermined number of times and outputs sound data constituting one frame to an external device. For example, the Audio Code Number 3 (AC-3) format provided by Dolby Laboratories requires repeating the processing 48 times before outputting sound data constituting one frame.

If there is no sound data remaining in the DAC-FIFO buffer memory 20 or the DIT-FIFO buffer memory 24, an audio apparatus may generate intermittent sounds. Therefore, the sound data processing apparatus 100 is required to supply sound data as quickly as possible in response to an interrupt signal. In this case, the DSP 12 is forced to stop the expansion processing and the decoding processing when an interrupt signal is input. In other words, the DSP 12 performs complicated processing. The processing performed by the DSP 12 may be delayed.

The above-described problem may be solved if the DAC-FIFO buffer memory 20 and the DIT-FIFO buffer memory 24 have a large memory capacity. However, the circuit scale of the sound data processing apparatus 100 becomes larger. The size of a required chip and the manufacturing cost increase significantly.

### SUMMARY OF THE INVENTION

According to an aspect of the present invention, a sound data processing apparatus includes a decoding processing unit configured to decode sound data having been coded; a first buffer memory configured to successively store the sound data processed by the decoding processing unit; a data reading control unit configured to read sound data from the first buffer memory and output the read sound data; a second buffer memory configured to store sound data received from the data reading control unit; and a data processing unit configured to perform predetermined processing on sound data input from the second buffer memory and output the processed sound data, and output an interrupt signal to the data reading control unit when the amount of sound data stored in the second buffer memory is equal to or less than a predetermined level, wherein the data reading control unit reads sound data from the first buffer memory in response to the interrupt signal if a read permission signal is in an enable state.

### BRIEF DESCRIPTION OF THE DRAWINGS

Exemplary embodiment of the present invention will be described in detail by reference to the following figures, wherein:

FIG. 1 is a block diagram illustrating a sound data processing apparatus according to an embodiment of the present invention;

FIG. 2 illustrates a method for storing data into a buffer memory according to an embodiment;

FIG. 3 illustrates an exemplary state of data stored in a buffer memory according to an embodiment;

FIG. 4 illustrates an exemplary state of data stored in a buffer memory according to an embodiment; and

FIG. 5 is a block diagram illustrating a conventional sound data processing apparatus.

### DESCRIPTION OF PREFERRED EMBODIMENTS

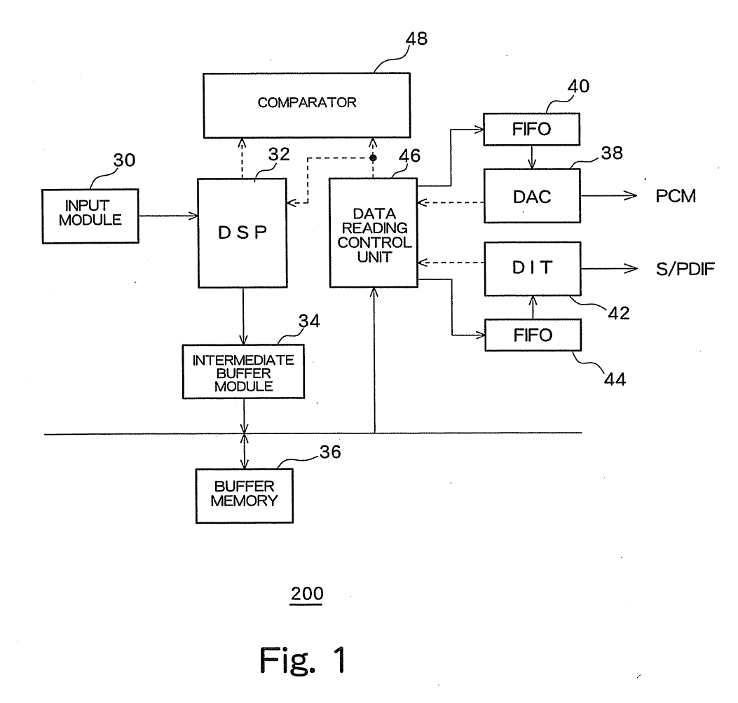

A sound data processing apparatus 200 according to an embodiment of the present invention includes, as illustrated in FIG. 1, an input module 30, a digital signal processor (DSP) 32, an intermediate buffer module 34, a buffer memory 36, a digital/analog converter (DAC) 38, a DAC-FIFO buffer 40 (i.e., an FIFO buffer memory dedicated to the DAC 38), a digital interface transmitter (DIT) 42, a DIT-FIFO buffer 44 (i.e., an FIFO buffer memory dedicated to the DIT 42), a data reading control unit 46, and a comparator 48.

The input module 30 receives sound data (i.e., data having been subjected to compression and coding processing) which is separated from a TS packet. The input module 30 transfers the received sound data to the DSP 32. The DSP 32 performs expansion processing and decoding processing on the input sound data and outputs processed sound data to the intermediate buffer module 34 if a read pointer value input from the data reading control unit 46 does not accord with a present write pointer value. The write pointer indicates a memory area of the buffer memory 36 that stores sound data. The read pointer indicates a memory area of the buffer memory 36 from which sound data are read out by the data reading control unit 46.

The buffer memory 36 has a memory capacity capable of storing sound data constituting a predetermined number of words. The capacity of the buffer memory 36 is, for example, 512 words or can be set to a value relevant to 3072 words (1536 words×2 channels) corresponding to one frame of the AC-3 format. The intermediate buffer module 34 receives sound data from the DSP 32 and performs predetermined processing on the received sound data. The processing performed by the intermediate buffer module 34 includes adjusting a bit width of the sound data according to a bus width of the buffer memory 36. The buffer memory 36 stores the sound data received from the intermediate buffer module 34. In this case, the intermediate buffer module 34 transfers each sound data block composed of 32 words×2 channels (corresponding to right sound and left sound) to the buffer memory 36. The buffer memory 36 successively stores sound data received from the intermediate buffer module 34.

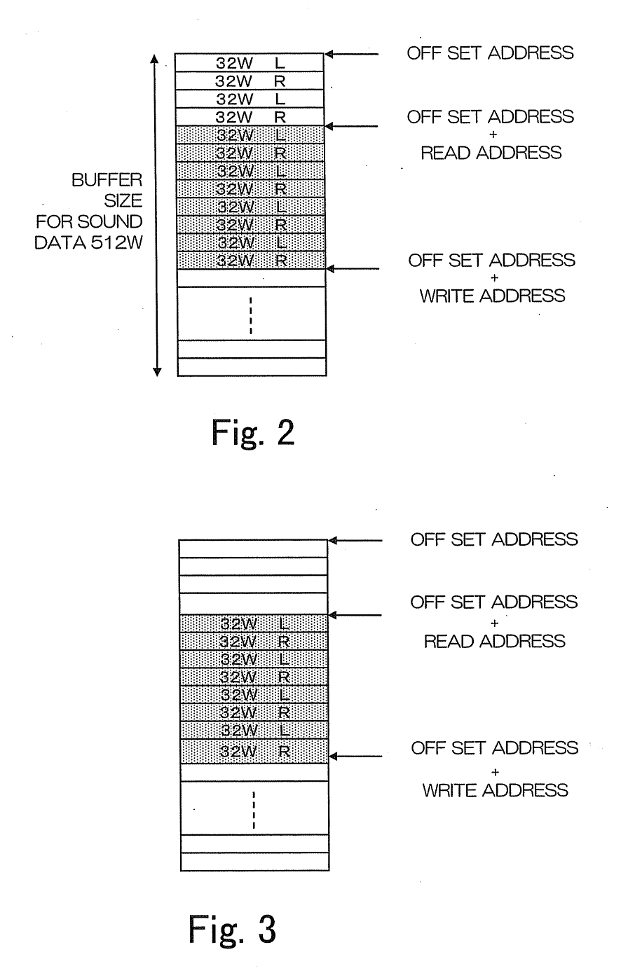

The buffer memory 36 can use its memory capacity as a ring buffer that can store sound data. For example, as illustrated in FIG. 2, when a memory space for the sound data is 512 words, sound data are successively stored in units of 64 words from a start address (offset address) of the memory space. When the memory space of 512 words is filled with sound data, the processing for storing sound data restarts from the beginning (i.e., offset address) of the memory space.

The DSP 32 updates the write pointer when the buffer memory 36 stores sound data. More specifically, as illustrated in FIG. 2, the offset address of the memory space is set to 0 and the allocated pointer increments by 1 in response to storage of sound data corresponding to 64 words. The DSP 32 successively transfers sound data to a memory area of the buffer memory 36 designated by the write pointer. The write pointer increments by 1 when the buffer memory 36 stores sound data corresponding to 32 words×2 channels (64 words). When the memory space ranging from the start address (offset address) to a final address is filled with sound data, the write pointer is reset to 0. In this manner, the buffer memory 36 functions as a ring buffer. The comparator 48 inputs a write pointer value.

The DAC 38 and the DAC-FIFO buffer 40 convert the sound data into data having an appropriate format that can be processed by a sound data D/A converter connected to the sound data processing apparatus 200, and output the converted sound data to the sound data D/A converter. The DAC-FIFO buffer 40, for example, includes a memory of 32 words×2 banks for each channel of sound data. The DAC-FIFO buffer 40 has a first-in first-out function. The DAC 38 successively reads sound data from the DAC-FIFO buffer 40, performs format conversion processing on the input sound data, and outputs the processed sound data to an external device. Furthermore, the DAC 38 outputs an interrupt signal to the data reading control unit 46 when the DAC-FIFO buffer 40 stores no sound data.

The DIT 42 and the DIT-FIFO buffer 44 convert the sound data into data having an appropriate format that can be processed by an external apparatus, and output the converted sound data to the external device. The DIT-FIFO buffer 44, for example, includes a memory of 32 words×2 banks for each channel of sound data. The DIT-FIFO buffer 44 has a first-in first-out function. The DIT 42 successively reads sound data from the DIT-FIFO buffer 44, performs format conversion processing on the input sound data, and outputs the processed sound data to an external device. Furthermore, the DIT 42 outputs an interrupt signal to the data reading control unit 46 when the DIT-FIFO buffer 44 stores no sound data.

The data reading control unit 46 reads a predetermined amount of sound data from a memory area of the buffer memory 36 designated by the read pointer in response to an interrupt signal input from the DAC 38 or the DIT 42, if a read permission signal from the comparator 48 is “enable.” Then, the data reading control unit 46 outputs the read sound data to the DAC-FIFO buffer 40 or the DIT-FIFO buffer 44. For example, the data reading control unit 46 successively reads sound data of 32 words (8 words×4 times) from the memory area designated by the read pointer. The data reading control unit 46 transfers the read sound data to the DAC-FIFO buffer 40 or the DIT-FIFO buffer 44. The DAC-FIFO buffer 40 or the DIT-FIFO buffer 44 receives the sound data and stores the received sound data in its memory area.

The data reading control unit 46 does not immediately read sound data from the buffer memory 36 in response to an interrupt signal received from the DAC 38 or the DIT 42, if the read permission signal from the comparator 48 is “disable.” Then, if the read permission signal becomes “enable,” the data reading control unit 46 starts reading sound data and outputs the read sound data to the DAC-FIFO buffer 40 or the DIT-FIFO buffer 44.

The data reading control unit 46 reads sound data from the buffer memory 36 and increments the read pointer according to an amount of the read sound data. For example, the data reading control unit 46 increments the read pointer by 1 when the amount of sound data having been read and transferred to the DAC-FIFO buffer 40 or the DIT-FIFO buffer 44 reaches 64 words=8 words×4×2 channels (right sound and left sound). Furthermore, the data reading control unit 46 resets the read pointer to 0 when the predetermined memory space is filled with the read sound data. In this manner, the data reading control unit 46 cyclically reads sound data from the buffer memory 36.

The comparator 48 controls the processing for reading data from the buffer memory 36. The comparator 48 receives the write pointer value from the DSP 32 and the read pointer value from the data reading control unit 46. When the write pointer value is different from the read pointer value, the comparator 48 sets the read permission signal to “enable.” If the write pointer value is equal to the read pointer value, the comparator 48 sets the read permission signal to “disable.”

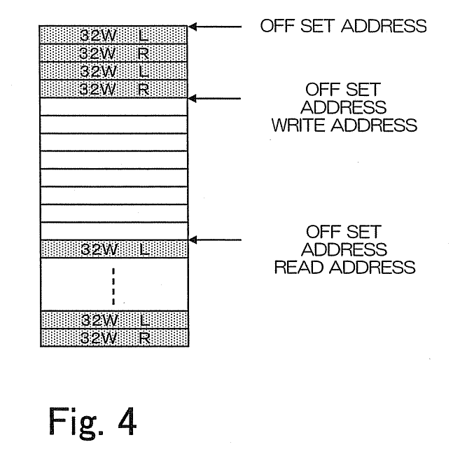

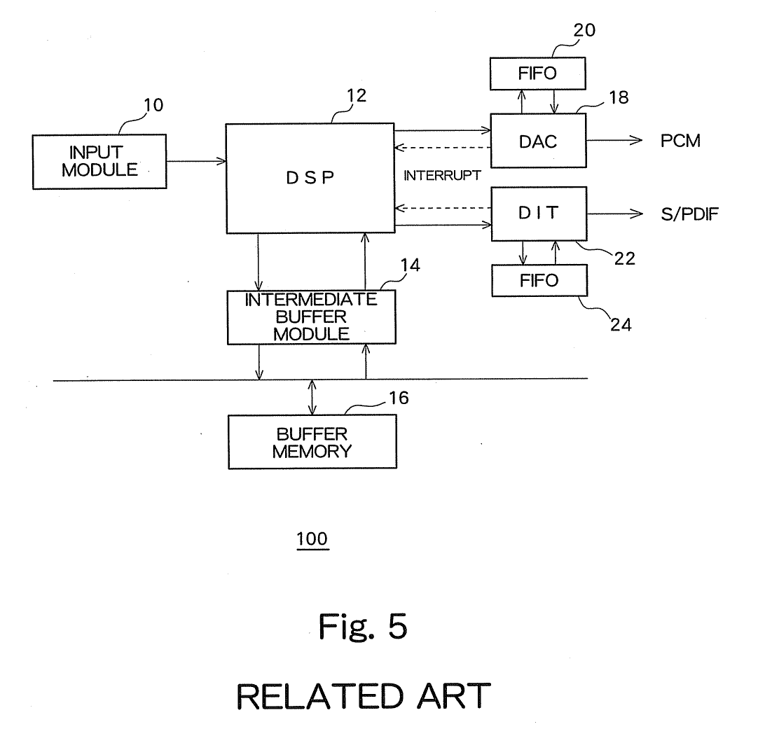

The writing of data into the buffer memory 36 is performed when the read pointer value disaccords with an addition of the write pointer value and 1. If the read pointer value is less than the write pointer value, a memory area ranging from a read pointer address to a write pointer address stores non-transferred sound data as illustrated in FIG. 3. As illustrated in FIG. 4, if the read pointer value is greater than the write pointer value, a memory area ranging from the start address (offset address) of the memory space to the write pointer address stores non-transferred sound data and a memory area ranging from the read pointer address to the final address of the memory space stores non-transferred sound data.

Accordingly, if the sound data reading processing is performed when the write pointer value disaccords with the read pointer value, the data reading control unit 46 can read sound data only when the buffer memory 36 stores non-processed sound data.

As described above, according to the present exemplary embodiment, the DSP 32 performs the expansion processing and the decoding processing on sound data. The DSP 32 outputs the processed sound data to the intermediate buffer module 34. And, the DSP 32 updates the write pointer. In other words, the DSP 32 is not required to perform the interrupt processing because the data reading control unit 46 can read sound data from the buffer memory 36 in response to an interrupt signal input from the DAC 38 or the DIT 42.

Furthermore, provision of the data reading control unit 46 capable of responding to an interrupt signal input from the DAC 38 or the DIT 42 brings an effect of reducing an interrupt time required for supplying sound data from the buffer memory 36 to the DAC-FIFO buffer 40 or the DIT-FIFO buffer 44. In this case, the time required for the processing is equivalent to a waiting time required for accessing the buffer memory 36. Accordingly, the DAC-FIFO buffer 40 and the DIT-FIFO buffer 44 do not require a large memory space and can use a memory whose capacity is relatively small.

A sound data processing apparatus included in a television or other receiving apparatus is configured to constantly receive a transport stream packet including video data and sound data. Therefore, the DSP 32 is required to quickly accomplish the expansion processing and the decoding processing applied to the received sound data. In this respect, the present exemplary embodiment can perform speedy sound data processing without causing any delay and, as a result, can eliminate intermittent sound output from a digital/analog converter.

Alternatively, for the purpose of providing a processing mode for repeatedly outputting sound data from the buffer memory 36, it is useful to fix the write pointer to a value in a range spaced from a setting range of the read pointer.

When the write pointer can be set to a value outside the setting range of the read pointer, a write pointer value never accords with a read pointer value. The data reading control unit 46 immediately reads sound data from the buffer memory 36 in response to an input interrupt signal, regardless of the presence of non-transferred sound data remaining in the buffer memory 36. Thus, the data reading control unit 46 reads sound data from the buffer memory 36 without checking whether the buffer memory 36 is updated with new sound data. If the buffer memory 36 is not updated with new sound data, the data reading control unit 46 repeatedly reads the same sound data and transfers the read sound data to the DAC-FIFO buffer 40 or the DIT-FIFO buffer 44. In this manner, the present embodiment can repeatedly output the same sound data from the buffer memory 36.

What is claimed is:

1. A sound data processing apparatus comprising:
a decoding processing unit configured to decode sound data having been coded;
a first buffer memory configured to successively store the sound data processed by the decoding processing unit;
a data reading control unit configured to read sound data from the first buffer memory and output the read sound data;
a second buffer memory configured to store sound data received from the data reading control unit; and
a data processing unit configured to perform predetermined processing on sound data input from the second buffer memory and output the processed sound data, and output an interrupt signal to the data reading control unit when the sound data stored in the second buffer memory is equal to or less than a predetermined amount,
wherein the data reading control unit reads sound data from the first buffer memory in response to the interrupt signal if a read permission signal is in an enable state.

2. The sound data processing apparatus according to claim 1, further comprising a comparator configured to compare a write pointer with a read pointer and set the read permission signal to a disable state when a write pointer value is equal to a read pointer value and to an enable state when the write pointer value is different from the read pointer value, wherein the write pointer indicates a memory area of the first buffer memory that stores sound data, the read pointer indicates a memory area of the first buffer memory from which sound data is read out by the data reading control unit, and the comparator outputs the read permission signal to the data reading control unit.

3. The sound data processing apparatus according to claim 1, wherein the write pointer can be set to a value in a range outside a setting range of the read pointer.

4. The sound data processing apparatus according to claim 1, wherein the sound data is separable from a transport stream packet.
